(19) United States
(12) Patent Application Publication
(10) Pub. No.: US 2005/0118499 A1
(43) Pub. Date: Jun. 2, 2005

(54) Secondary battery

(76) Inventor: Yong-Sam Kim, Suwon-si (KR)

Correspondence Address: ROBERT E. BUSHNELL, 1522 K STREET NW, SUITE 300, WASHINGTON, DC, 20005-1202, US

(21) Appl. No.: 10/989,450

(22) Filed: Nov. 17, 2004

(30) Foreign Application Priority Data
Nov. 29, 2003 (KR) 10-2003-0086086

(51) Int. Cl. H01M 2/14; H01M 2/08; H01M 2/26

(52) U.S. Cl. 429/129; 429/185; 429/161

(57) ABSTRACT

A secondary battery includes an electrode assembly having a positive plate, a negative plate, and a separator interposed between the positive plate and the negative plate; a container receiving the electrode assembly; a cap assembly fixed to the container to seal the container; a collecting member electrically connected to at least one of the positive and negative plates; and an insulating member disposed between the container and the collecting member to insulate the container from the collecting member.

### CLAIM OF PRIORITY

This application makes reference to, incorporates the same herein, and claims all benefits accruing under 35 U.S.C. § 119 from an application for SECONDARY BATTERY earlier filed in the Korean Intellectual Property Office on 29 Nov. 2003 and there duly assigned the Serial No. 2003-86086.

### BACKGROUND OF THE INVENTION

1. Field of the Invention

The present invention relates to a secondary battery, and more particularly, to a secondary battery with a structure for preventing a short circuit between a collecting member and a container.

2. Description of the Related Art

Unlike the primary battery, the secondary battery may be recharged. Common types of secondary batteries may be made into a battery pack and used as the power source for various portable electronic devices such as cellular phones, laptop computers, and camcorders. In particular, the lithium secondary battery among the secondary batteries is more suitable for the portable electronic devices since it has a high driving voltage and a high energy density per unit weight.

Furthermore, bulk size batteries which have several to tens of battery cells connected to each other to be used as a battery pack unit, are suitable for the power source of motor drive of hybrid electric vehicles.

Depending on the external shape, secondary batteries maybe classified into different types, for example, square and cylindrical batteries. The cylindrical-shaped secondary battery includes an electrode assembly (jellyroll) in which a positive plate and a negative plate of a long belt shape, and a separator as an insulator interposed therebetween are spiral-wound, a cylindrical container receiving the electrode assembly, and a cap assembly fixed to the container and electrically connected to the electrode assembly to thereby seal the container.

The positive and negative plates have lead members, i.e. tabs for collecting the current produced from the positive and negative plates when the battery is operated. The tab is fixed to the cap assembly or the container to induce the current produced from the positive and negative plates to the positive and negative terminals.

In that case, if only a single tab is provided, the resistance against the tab is increased and, accordingly, the power of the battery can be decreased. In an effort to overcome this difficulty, there has been provided a secondary battery which has the positive and negative plates with plural tabs.

In the meantime, there has been provided a secondary battery in which an uncoated region being left uncoated with the active material corresponding to each of collectors of the positive and negative plates is formed on the one end of the positive and negative plates, and the uncoated region is directly fixed to the collector plate by a method such as laser welding. That is, the collector plate for collecting the current from the positive and negative plates is electrically contacted with as large an area as possible of the positive and negative plates to improve the power of the battery.

However, such secondary batteries have a problem in that there is a high possibility that a short circuit can occur by contacting plural tabs or collector plates with the inside wall of the container, when or after the electrode assembly fixed to plural tabs and collector plates is inserted into the container during the manufacturing process.

### SUMMARY OF THE INVENTION

It is, therefore, an object of the present invention to provide a method and an apparatus that can prevent a short circuit between a collecting member and a container.

It is another object to provide a secondary battery that can provide a highly reliable source of power with reduced faults over a period of use and can be used as the power source for a plurality of devices including for example but not limited to hybrid electric vehicles, electric vehicles, wireless vacuum cleaners, motorbikes, and motor scooters.

It is yet another object to provide a secondary battery that is more reliable and yet be efficient and cost effective.

It is still another object to provide an a apparatus and technique for a secondary battery that can prevent a short circuit during manufacture and after manufacture of the secondary battery.

There is provided a secondary battery which can prevent a short circuit between a collecting member and a container.

According to one aspect of the present invention, a secondary battery includes an electrode assembly having a positive plate, a negative plate, and a separator interposed between the positive plate and the negative plate; a container receiving the electrode assembly; a cap assembly fixed to the container to seal the container; a collecting member electrically connected to at least one of the positive and negative plates; and an insulating member disposed between the container and the collecting member to insulate the container from the collecting member.

The insulating member can be fixed to the outer portion of the electrode assembly, and one end of the electrode assembly can be placed in the insulating member.

The insulating member can be fixed to the outer portion of the electrode assembly, and one end of the electrode assembly and the collecting member can be placed in the insulating member.

The insulating member can be fixed to the outer portion of the electrode assembly, and can be placed to cover at least a portion of the collecting member.

The collecting member can be formed in a plate shape, and the collecting member can be contacted with an uncoated region which is formed by not coating with the active material on at least a portion of a collector of the positive or negative plate.

The collecting member can be formed in a ring shape, and the collecting member can be electrically connected with plural tabs which are electrically connected to the positive or negative plate. In addition, the insulating member wraps the collecting member to contact one end thereof with at least a portion of the collecting member.

The insulating member is formed in a tape or film shape.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of a secondary battery according to the first embodiment of the present invention;

FIG. 2 is a schematic partial exploded perspective view of an electrode assembly according to the embodiment of the present invention;

FIG. 3 is a partial perspective view illustrating the structure of fixing the insulating member to the electrode assembly according to the first embodiment of the present invention;

FIG. 4 is a cross-sectional view of a secondary battery according to the second embodiment of the present invention;

FIG. 5 is a plan view illustrating the structure of welding lines formed on the collecting members according to the first and second embodiments of the present invention;

FIG. 6 is a cross-sectional view of a secondary battery according to the third embodiment of the present invention; and

FIG. 7 is a partial perspective view of the secondary battery according to the third embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

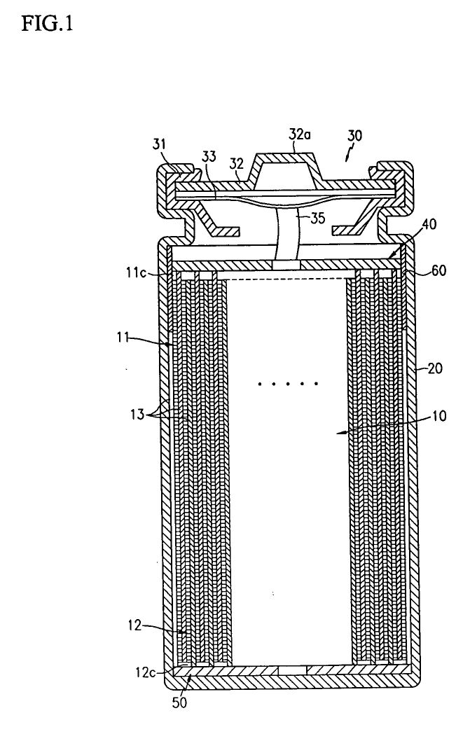

FIG. 1 is a cross-sectional view of a secondary battery according to the first embodiment of the present invention.

As shown in FIG. 1, the secondary battery includes an electrode assembly 10 having a positive plate 11, a negative plate 12 and a separator 13 interposed between those two plates, positive plate 11 and negative plate 12; a container 20 having an opening formed on one of its sides to receive the electrode assembly 10 together with an electrolyte; a cap assembly 30 mounted to the opening of the container 20 through a gasket 31 to thereby close off and seal the container 20; a positive collecting member 40 electrically connected to the positive plate 11 of the electrode assembly 10; and a negative collecting member 50 electrically connected to the negative plate 12 of the electrode assembly 10.

More specifically, the container 20 is made of conductive metal such as aluminum, aluminum alloy, and steel plated with nickel, and it has a cylindrical shape which has an inner space to receive the electrode assembly 10.

Although the secondary battery explained in the exemplary embodiment has a cylindrical shape, its shape is not limited to this shape and can be other than cylindrical, for example, square.

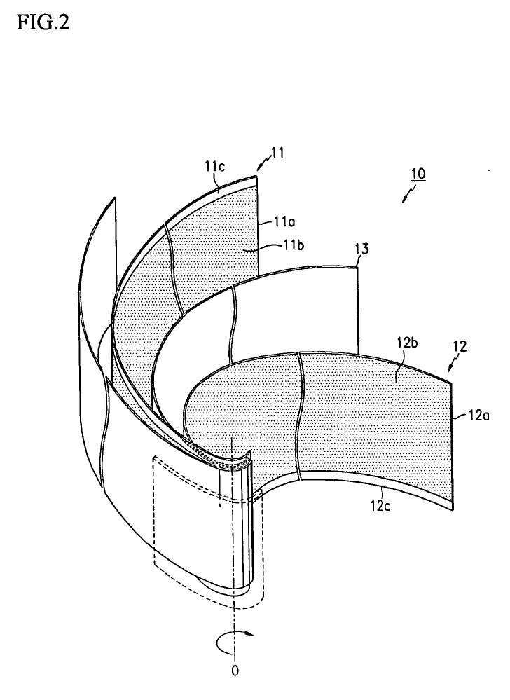

The electrode assembly 10 has a stacked layer structure such that the separator 13 is placed between the positive plate 11 and the negative plate 12, the collectors of which are coated with the corresponding active materials, or it has a jellyroll structure such that the positive plate 11, the negative plate 12 and the separator 13 in a stacked layer are wound into a jellyroll configuration (FIG. 2). FIG. 1 shows a structure that the electrode assembly 10 in a round jellyroll configuration is mounted inside the cylindrical container 20.

In the exemplary embodiment of the present invention, the collecting members 40, 50 are made with a plate-shaped conductive member, and are respectively fixed (secured) to the uncoated regions 11c, 12c of the positive plate 11 and the negative plate 12, respectively, by welding.

That is, in the lower end (for FIG. 1) of the negative plate 12, the uncoated region 12c of the collector 12a of the negative plate 12 which is not coated with the negative active material 12b is formed along the longitudinal direction of the negative plate 12 to contact with the negative collecting member 50. In the upper end (for FIG. 1) of the positive plate 11, the uncoated region 11c at the edge of the collector 11a of the positive plate 11 which is not coated with the positive active material 11b is formed along the longitudinal direction of the positive plate 11 to electrically connected with the positive collecting member 40.

The cap assembly 30 includes a cap plate 32 having an external terminal 32a, and a gasket 31 insulating the cap plate 32 from the container 20. It can further include a vent plate 33 which is broken at a prescribed pressure level to discharge the gas, thereby preventing the explosion of the battery. The vent plate 33 is electrically connected to the positive collecting member 40 through a lead 35.

The vent plate 33 can be modified into various configurations as long as it performs cutoff of the electrical connection between the external terminal 32a and the electrode assembly 10 through the lead 35 at a prescribed pressure level.

Each of the uncoated regions 11c, 12c of the positive and negative plates, when the electrode assembly 10 is formed, is arranged to project from the separator 13.

Furthermore, an insulating member 60 is arranged between at least one of the collecting members 40, 50 (the positive collecting member 40 in the exemplary embodiment) and the container 20 of the secondary battery to insulate each other.

The insulating member 60 has a role in preventing a short circuit which can occur by contacting the collecting members 40, 50 with the inside wall of the container 20 when or after the electrode assembly 10, having the collecting members 40, 50 at its both ends, is inserted into the container 20.

The insulating member 60 can be formed with a tape or a film consisting of the conductive material.

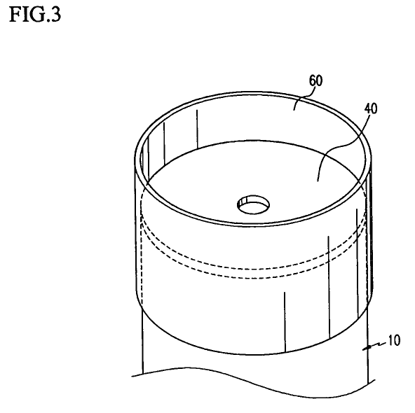

As shown in FIG. 3, the insulating member 60 of the present exemplary embodiment is fixed (or secured) to the outer portion of the electrode assembly 10, and when the insulating member 60 is arranged between the collecting member 40 and the container 20, the insulating member 60 enables its upper end to be located at a higher position than the upper end of the electrode assembly 10 or the upper end of the collecting member 40.

That is, while the insulating member 60 is fixed to the electrode assembly 10, one end of the electrode assembly 10 (the upper portion for FIG. 1) or the collecting member 40 is placed in the insulating member 60.

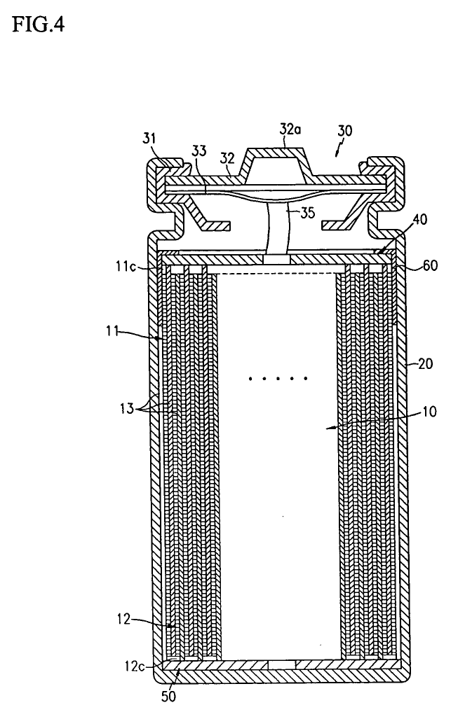

The structure of the insulating member 60 of the present invention which is fixed to the electrode assembly 10 is not limited to the above. FIG. 4 shows another exemplary embodiment, in which the insulating member 60 can be fixed to cover at least a portion of the collecting member 40 (the upper surface of the collecting member 40 for FIG. 1).

If the electrode assembly 10 is inserted into the container 20 while the insulating member 60 is fixed to the electrode assembly 10, the collecting member 40 can maintain the coverage with the insulating member 60. Therefore, it can prevent contacting with the inside wall of the container 20, and also prevent the short circuit, and thereby prevent the manufacture of faulty batteries.

The above effects of the insulating member 60 can be expected not only when the electrode assembly 10 is inserted into the container 20 upon manufacturing of the battery, but also after the insertion, i.e. when the battery is operated after the completion of manufacturing the battery.

In the meantime, the collecting members 40, 50 are respectively fixed to the uncoated regions 11c, 12c of the positive and negative plates 11, 12 by laser welding and thereby welding lines are formed on the collecting members 40, 50 of the above secondary battery.

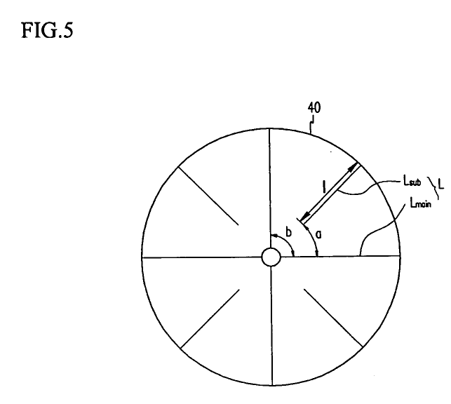

FIG. 5 is a plan view illustrating the structure of welding lines formed on the positive collecting member 40 of the collecting members 40, 50. As shown in FIG. 5, the welding lines L are formed in plural on the collecting member 40, and include main welding lines Lₘₐᵢₙ and sub welding lines L_{sub}.

The main welding lines Lₘₐᵢₙ are arranged on a virtual straight lines extending from the center of the electrode assembly 10 toward the outermost of the electrode assembly 10, and the sub welding lines L_{sub} are arranged between the main welding lines Lₘₐᵢₙ. Then, the sub welding lines L_{sub} are formed with a predetermined length not extending from the outermost toward the center of the electrode assembly 10, rather than a full length.

It is preferable that the length (1) of the sub welding line L_{sub} extends as long as the gap (a) between the sub welding line L_{sub} and the adjacent main welding line Lₘₐᵢₙ equals the least gap (b) between each of the main welding lines Lₘₐᵢₙ.

If the length (1) of the sub welding line L_{sub} is shorter than the least gap (b) of the main welding lines Lₘₐᵢₙ, the collection against the center of the electrode assembly 10 becomes more dependent on the collecting member 40 based on the main welding lines Lₘₐᵢₙ. Accordingly, it causes the power against the center of the electrode assembly 10 to decrease, and thereby the life span of the battery is decreased.

Another exemplary example in which the structure of the collecting member is modified will be described in the following.

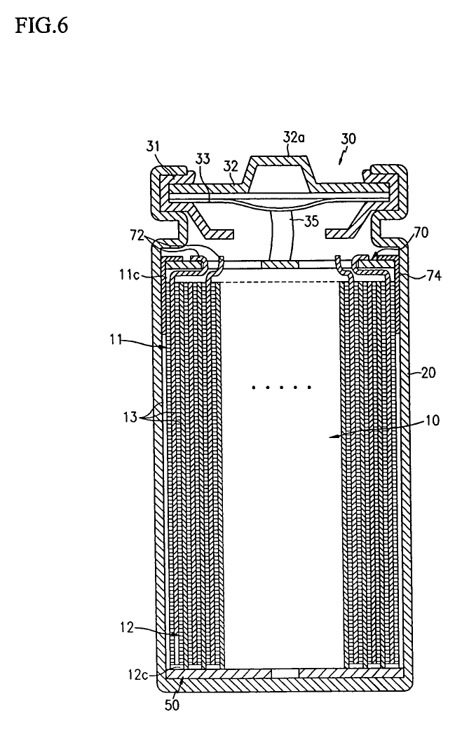

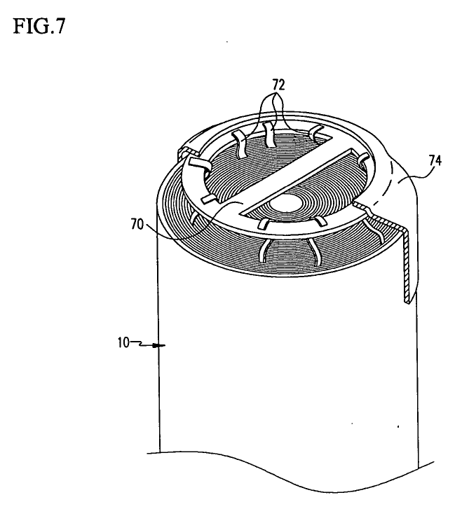

As shown in FIG. 6 and FIG. 7, the collecting member 70 for collecting the current from the positive plate 11 of the electrode assembly 10 is formed with a ring shaped conductive material. The collecting member 70 is arranged at the one end of the electrode assembly 10, and has plural tabs 72 electrically connected to the collector of the positive plate 11.

Then, a special member can be provided with the inside of the container 20 receiving the electrode assembly 10 to support and fix the collecting member 70.

For the secondary battery having the above collecting member 70, an insulating member 74 as mentioned above can be placed between the collecting member 70 and the container 20.

The structure and material of the insulating member 74 can be achieved as mentioned above, and FIG. 6 and FIG. 7 show that the insulating member 74 wraps entirely the collecting member 70 and covers a portion of the upper surface of the collecting member 70.

The secondary battery of the present invention can also be used as the power source for the hybrid electric vehicles, electric vehicles, wireless vacuum cleaners, motorbikes, and motor scooters.

Although a few embodiments of the present invention have been shown and described, it would be appreciated by those skilled in the art that changes may be made in this embodiment without departing from the principles and spirit of the invention, the scope of which is defined in the claims and their equivalents.

1. A secondary battery comprising:
an electrode assembly having a positive plate, a negative plate, and a separator interposed between said positive plate and said negative plate;
a container receiving said electrode assembly;
a cap assembly fixed to said container to seal said container;
a collecting member electrically connected to at least one of said positive and negative plates; and
an insulating member disposed between said container and said collecting member to insulate said container from said collecting member.

2. The secondary battery of claim 1, wherein the insulating member is fixed to the outer portion of said electrode assembly, and one end of said electrode assembly is placed in said insulating member.

3. The secondary battery of claim 1, wherein said insulating member is fixed to the outer portion of said electrode assembly, and one end of said electrode assembly and said collecting member are placed in the insulating member.

4. The secondary battery of claim 1, wherein said insulating member is fixed to the outer portion of said electrode assembly, and covers at least a portion of the collecting member.

5. The secondary battery of claim 1, wherein said collecting member is formed in a plate shape.

6. The secondary battery of claim 5, wherein the collecting member is contacted with an uncoated region which is formed by not coating with the active material on at least a portion of a collector of said positive or negative plate.

7. The secondary battery of claim 1, wherein said collecting member is formed in a ring shape.

8. The secondary battery of claim 7, wherein said collecting member is electrically connected with plural tabs which are electrically connected to said positive or negative plate.

9. The secondary battery of claim 7, wherein said insulating member wraps the collecting member and covers at least a portion of said collecting member.

10. The secondary battery of claim 1, wherein said collecting member is a positive collector plate.

11. The secondary battery of claim 1, wherein said secondary battery is in a cylindrical shape.

12. The secondary battery of claim 1, wherein said secondary battery is for a motor drive.

13. The secondary battery of claim 7, wherein said collecting member is welded to an uncoated region by laser.

14. The secondary battery of claim 13,
wherein welding lines in a radial shape are formed on said collecting member by laser;
wherein the welding lines includes main lines arranged on virtual straight lines extending from the center of the electrode assembly toward the outermost of said electrode assembly, and sub lines arranged between the main lines with a predetermined length from the outermost toward the center of the electrode assembly; and
wherein the length of the sub line extends as long as the gap between the sub line and the adjacent main line equals the least gap between each other of the main lines.

15. The secondary battery of claim 1, wherein said insulating member is formed in a tape or film shape.

16. An apparatus for preventing short circuit in a secondary battery, comprising:
an insulating member disposed between a container and a collecting member to insulate said container from said collecting member, said container receiving an electrode assembly with a plate of a first conductivity type and a plate of a second conductivity type, said collecting member electrically connected to at least one of said plate of first conductivity type and said plate of second conductivity type.

17. The apparatus of claim 16, further comprising a conductive member of said collective member being secured to uncoated regions of said plate of first conductivity type through a laser welding with first and second welding lines, the first welding lines being approximately straight lines extending from a center to a periphery of said electrode assembly and said second welding lines positioned between said first welding lines and extending a predetermined length less than the length from the periphery to the center of said electrode assembly.

18. The apparatus of claim 16, further comprised of said insulating member being secured to cover an upper surface of said collecting member, the upper surface being toward a cap assembly secured to seal said container.

19. The apparatus of claim 16, further comprised of said collecting member including a ring shape with a plurality of tabs electrically connected to said collecting member of said plate of first conductivity, and said insulating member wrapping entirely around said collecting member and covering a portion of an upper surface of said collecting member.

20. A secondary battery, comprising of:
an electrode assembly including a first conductivity type plate, a second conductivity type plate, and a separator interposed between said first conductivity type plate and said second conductivity type plate;
a container receiving said electrode assembly;
a collecting member electrically connected to at least one of said first conductivity type plate and said second conductivity type plate; and
an insulating member disposed between said container and said collecting member to insulate said container from said collecting member.

21. The apparatus of claim 20, further comprised of said collective member being secured to an uncoated region of said plate of first conductivity type through a laser welding with first and second welding lines, the first welding lines being approximately straight lines extending from a center to a periphery of said electrode assembly and said second welding lines positioned between said first welding lines and extending a predetermined length less than the length from the periphery to the center of said electrode assembly.

22. The apparatus of claim 20, further comprised of said insulating member being secured to cover a side and an upper surface of said collecting member, with the side being toward a side wall of said container.

23. The apparatus of claim 20, further comprised of said collecting member including a shape bounded by a curved line with a plurality of tabs electrically connected to said collecting member of said plate of first conductivity, and said insulating member wrapping entirely around said collecting member and covering a portion of an upper surface of said collecting member.
